(19) United States
(12) Patent Application Publication
(10) Pub. No.: US 2019/0139412 A1
(43) Pub. Date: May 9, 2019

(54) BLIND SPOT INFORMATIVE SYSTEM AND METHOD THEREOF

(71) Applicants: Mindtronic AI Co.,Ltd., Grand Cayman (KY); Shanghai XPT Technology Limited, Shanghai City (CN)

(72) Inventors: Mu-Jen Huang, Taipei City (TW); Ya-Li Tai, Taoyuan City (TW); Yu-Sian Jiang, Kaohsiung City (TW)

(21) Appl. No.: 15/995,094

(22) Filed: May 31, 2018

(30) Foreign Application Priority Data
Nov. 8, 2017 (CN) 201711088659.7
Nov. 8, 2017 (CN) 201721475238.5

(51) Int. Cl. G08G 1/16; B60Q 9/00; G08G 1/0962

(52) U.S. Cl. CPC G08G 1/166; G08G 1/09626; G08G 1/164; B60Q 9/008

(57) ABSTRACT

A blind spot informative system includes a sensing module, an arithmetic unit and a display device. The sensing module is disposed in a vehicle, wherein the sensing module is configured to obtain parameters of an object nearby a vehicle. The arithmetic unit is configured to evaluate a chance that the object would collide with the vehicle and, if applicable, an estimated time of collision based on the parameters. The display device is configured to display the estimated time of collision to the driver for avoiding the collision.

### BACKGROUND OF THE INVENTION

### 1. Field of the Invention

The present invention relates to a blind spot informative system and a method thereof, and more particularly to a blind spot informative system and a method thereof that provides relevant information and recommendations to assist driver for the prevention of collisions.

### 2. Description of the Prior Art

Modern vehicles install various apparatuses to enhance safety. Nowadays, in addition to the traditional safety systems, such as anti-lock braking system (ABS), electronic brake-force distributor (EBD), traction control system (TRC), electronic stability control (ESC), supplemental restraint system (SRS), etc., much attentions are given to advance driver assistance systems (ADAS). On top of ADAS, a blind spot detection system provides warming to drivers about the existence of obstacles not seen by drivers. Radars are adapted to detect obstacles within the blind spots around a vehicle. The detection system then alters the driver if any object is spotted so that the driver can act accordingly.

### SUMMARY OF THE INVENTION

An embodiment of the present invention provides a blind spot informative system. The system includes: a sensing module disposed in a vehicle and configured to detect and gather a plurality of parameters of an object nearby the vehicle; an arithmetic unit configured to evaluate a chance the object would collide with the vehicle and, if a collision is foreseeable, an estimated time of collision based on the parameters and available data; and a display device configured to display the estimated time of collision to inform a driver of the vehicle.

Another embodiment of the present invention provides an informative method including: collecting parameters of an object nearby a vehicle upon a detection of the object, wherein the parameters at least include the velocity of the object and the distance between the object and the vehicle; estimating a chance that the object would collide with the vehicle based on the parameters, and if the collision is foreseeable, an estimated time of collision; and presenting the estimated time of collision to a driver of the vehicle.

A further embodiment of the present invention discloses a blind spot informative system implemented in a vehicle driving in accordance with a planned route. The system includes: a sensing module disposed in a vehicle and configured to detect an object within a blind spot of the vehicle and collect a velocity of the object and a distance between the object and the vehicle; an arithmetic unit connected to the sensing module and configured to evaluate a chance the object would collide with the vehicle, and if the collision is foreseeable, an estimated time of collision based on the planned route, the velocity of the object and the distance between the object and the vehicle; and a display device configured to display the estimated time of collision in line with the planned route to a driver of the vehicle.

Apart from the foregoing, the blind spot information system and method thereof further provides at least one feasible advice to the driver of the vehicle for the avoidance of the collision. Additionally, the degree of urgency in response to the collision may also be assessed for the driver's reference. Therefore, by implementing the present invention, the overall safety can be enhanced.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram showing a blind spot informative system of an embodiment according to the present invention.

FIG. 2 is a schematic diagram showing a process flow of a blind spot informative method according to a first embodiment of the present invention.

FIG. 3 is a schematic diagram showing a process flow of a blind spot informative method according to a second embodiment of the present invention.

FIG. 4 is a schematic diagram showing a display picture of the display device according to the second embodiment the present invention.

FIG. 5 is a schematic diagram showing a process flow of a blind spot informative method according to a third embodiment of the present invention.

FIG. 6 is a schematic diagram showing a process flow of the blind spot informative method according to the present invention.

### DETAILED DESCRIPTION

To provide a better understanding of the present invention, preferred embodiments will be explained in the following paragraphs. The preferred embodiments of the present invention are illustrated in the accompanying drawings with numbered elements to elaborate on the contents and effects to be achieved. It should be noted that the drawings are simplified schematics, and therefore show only the components and combinations associated with the present invention, in order to provide a clearer description of the basic architecture or method of implementation. The components would be complex in reality. In addition, for ease of explanation, the components shown in the drawings may not represent their actual number, shape, and dimensions; details can be adjusted according to design requirements.

The present invention provides a blind spot informative system that not only detects obstacles in blind spots of a vehicle, but also provides information and advices for the driver to act upon it.

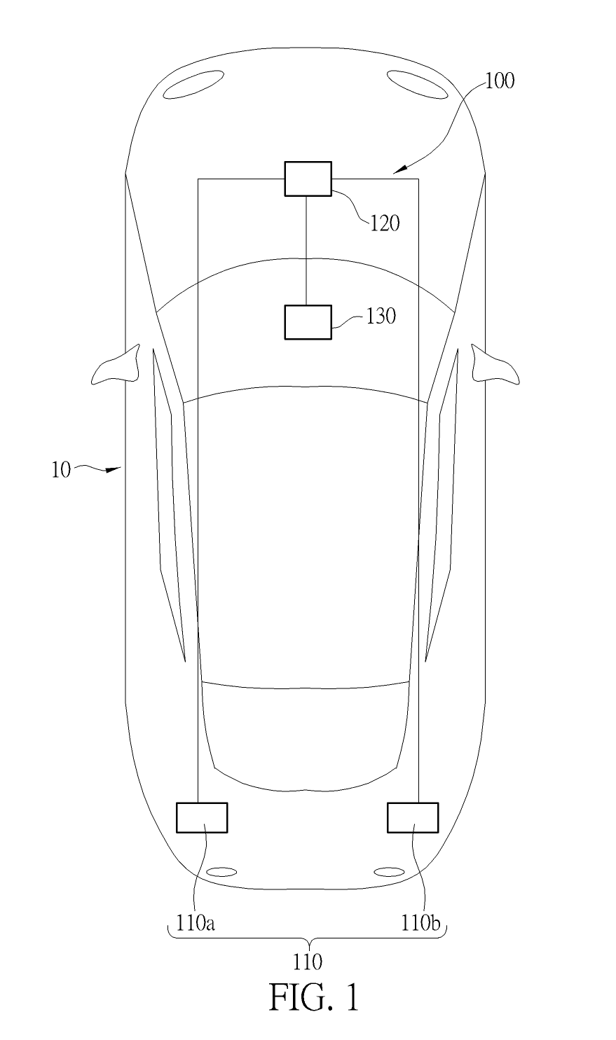

FIG. 1 illustrates a blind spot informative system 100 in accordance with one embodiment of the present invention. As shown, the blind spot informative system 100 is disposed in a vehicle 10. The system 100 includes a sensing module 110, an arithmetic unit 120 and a display device 130. The sensing module 110 may be arranged in any places of the vehicle 10 capable of sensing surrounding objects clearly. For instance, it may be disposed at the front part, the rear part, the left side and the right side of the vehicle 10. For example, without limitation, the sensing module 110 shown in FIG. 1 is positioned at the rear bumper of the vehicle 10. The sensing module 110 is configured to sense the statuses, the directions and the velocities of the objects nearby the vehicle 10, and the distances between the vehicle 10 and the objects. The objects may be any approaching vehicles, obstacles (such as pedestrians, falling merchandise), etc. In addition, the sensing module 110 may derive a relative velocity between the vehicle 10 and an object directly, or it may obtain the velocities of the vehicle 10 and the object separately and calculate the difference. In the context of the present invention it is critical to at least understand the distance and the relative velocity between the vehicle 10 and the object for the sake of rendering recommendation.

Moreover, the system 100 may optionally include sub-sensing modules. For instance, as shown in FIG. 1, the sensing module 110 further has a first sub-sensing module 110a and a second sub-sensing module 110b. The first sub-sensing module 110a is used to recognize objects nearby the left-rear side of the vehicle 10, while the second sub sensing module 110b is provided to detect objects close to the right-rear side of the vehicle 10. It should be noted that the above is a mere example; alternatively, the sensing module 110 may be a single sensor and it may have more than two sub-sensing modules. On the implementation side, in one embodiment, the sensing module 110 may emit short-wavelength wireless signals (such as millimeters) and determine whether the object is within a defined zone and, if so, how far it is and what the velocity is, etc. based on the durations that the bouncing signals are received.

Those parameters (e.g. the distance, the relative velocity, etc.) collected by the sensing module 110 are sent, through physical connections or wirelessly, to the arithmetic unit 120 upon which the arithmetic unit 120 estimates informative data between the vehicle 10 and the nearby object. The content of the informative data will be explained in detail below. The display device 130 then presents the informative data to inform the driver. In the present invention, the display device 130 may be, for instance without limitation, a center informative display (CID), a head up display (HUD), or a display disposed on the windshield, the window, the sunroof, the dashboard, the rearview mirror, the right rearview mirror or the left rearview mirror of the vehicle 10.

Apart from the sensing module 110, to provide proper advices to the driver, the system 100 may also include sensors (or sensor-like devices) disposed on the vehicle capable of collecting data of the vehicle 10. The data may include, without limitation, the status, the direction and the speed of the vehicle 10. Additionally, the vehicle 10 may also equip with communication facilitates capable of receiving, for instance, traffic condition, map, and GPS data, etc. Based on all the available information, including without limitations, the route, the speed and the direction of the vehicle 10, the status of the nearby object, moving or still, the speed and the direction of the nearby object, if it is moving, and the distance and the relative velocity between the vehicle 10 and the nearby object, etc. the arithmetic unit 120 estimates, for instance without limitations, the chance the vehicle 10 will collide with the nearby object and, if so, when (i.e. how many time left for the driver of the vehicle 10 to react). Moreover, the arithmetic unit 120 may further evaluate, if the collision is foreseeable, what options the driver has to avoid it. For instance, whether the driver of the vehicle should slow down, speed up, make a turn, or change the drive lane, and in which direction to avoid the situation. The results therefore obtained are collectively called the informative data which will be, entirely or selectively, presented on the display device 130. Thus, instead of merely issuing a warming sound/signal to alert the driver, the present blind spot informative system 100 takes an even more advanced approach to assist the driver and eliminate the risk of collision.

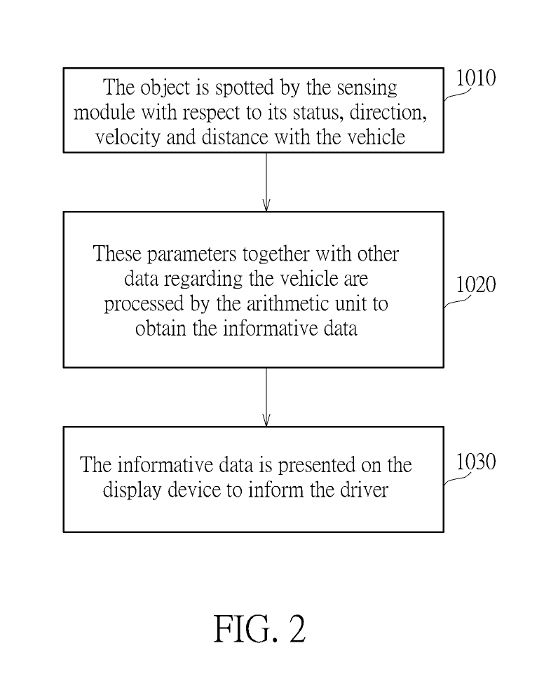

FIG. 2 shows the least steps for providing informative data in accordance with an embodiment of the present invention. Assuming there is an object nearby the rear-left side of the vehicle 10 and the object is spotted by the sensing module 110 (the sub-sensing module 110a particularly) with respect to its status, direction, velocity and distance with the vehicle 10 (step 1010). These parameters together with other data regarding the vehicle 10 are processed by the arithmetic unit 120 to obtain the informative data (step 1020). In one embodiment, the informative data may include, if the driver of the vehicle 10 does not do anything to respond it, the chance the object would collide with the vehicle 10, and the estimated time of the collision, etc. The informative data is presented on the display device 130 to inform the driver (step 1030).

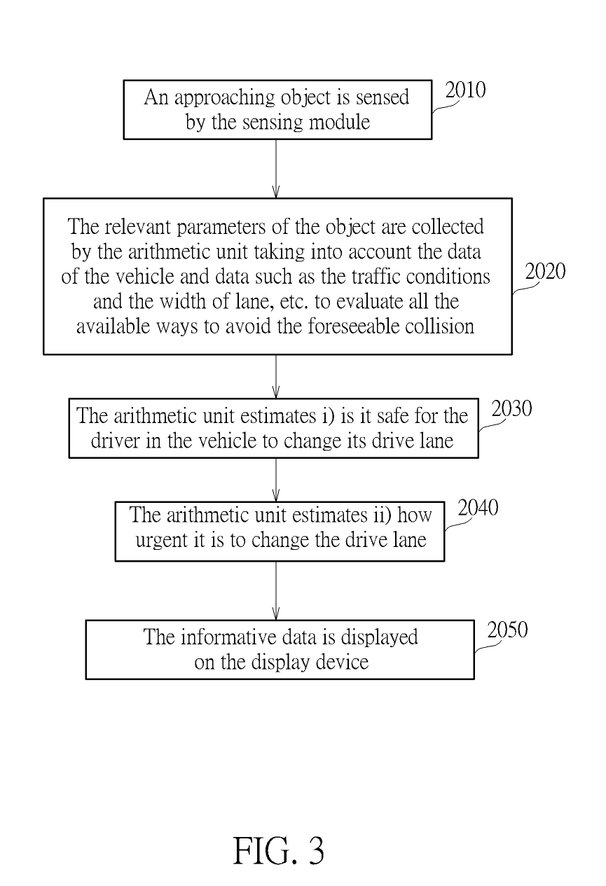

Apart from that, in another embodiment, the present invention may take a further step to advise the driver of the vehicle 10 about the avoidance of the possible collision. The method is illustrated in FIG. 3. Assuming the vehicle 10 is moving forward and an approaching object is sensed by the sensing module 110 (step 2010). As reiterated, the relevant parameters, including the status, the distance, the velocity, and the direction, etc. of the object are collected by the arithmetic unit 120 taking into account the data of the vehicle 10 and data such as the traffic conditions (e.g. any speed limitations, restrictions, other objects also around the vehicle 10), and the width of lane, etc. to evaluate all the available ways to avoid the foreseeable collision (step 2020). For instance, if the object is approaching at the rear-right side of the vehicle 10, the arithmetic unit 120 may advise the driver of the vehicle 10 to change its drive lane to the left provided there is no other obstacles there. To make this recommendation, the arithmetic unit 120 may estimate i) is it safe for the driver in the vehicle 10 to change its drive lane (step 2030), and if so ii) how urgent it is to change the drive lane (step 2040). Under this scenario, the informative data, including not only the chance and the estimated time of collision, but also recommendations to avoid the collision, is displayed on the display device 130 (step 2050).

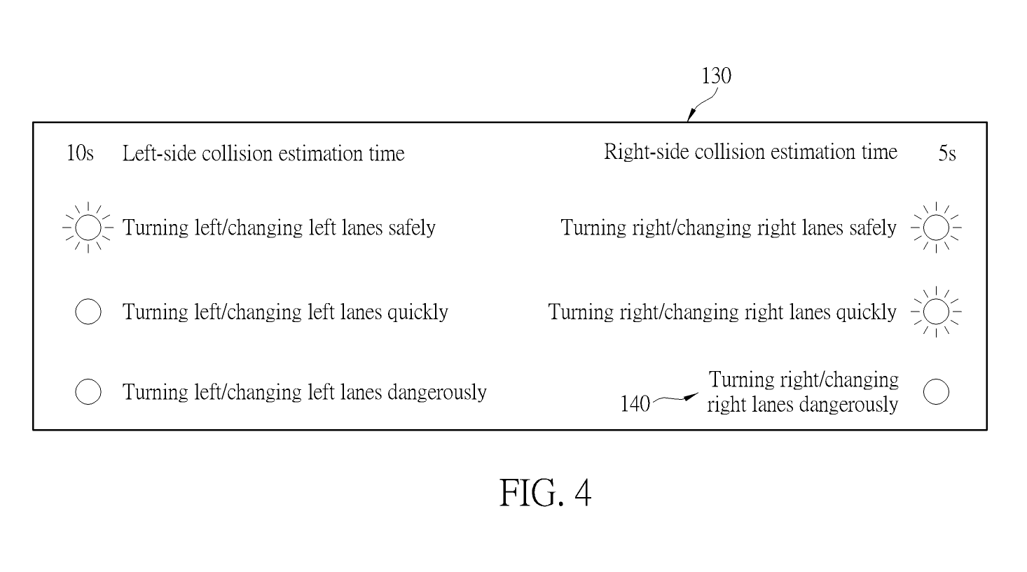

FIG. 4 examples an embodiment in which the display device 130 may display the informative data to assist the driver. As can be seen, the estimated time of collision at each side is shown on the first line of the display device 130. i.e. 10 and 5 seconds, respectively. Additionally, a corresponding indicator on the display device 130 may be, for example, flashing to inform the driver as to how to react. In one example shown in FIG. 4, the system 100 determinates that the estimated time of collision at the left-hand side is 10 seconds, and the indicator informing that it is safe to change the drive lane to left (or make a left-turn) is flashing.

As mentioned, the informative data may further include the degree of urgency (e.g. immediately or smoothly) in response to the collision. In another embodiment, as shown in FIG. 4, the system 10 determines and display the estimated time of collision at the right-hand side is 5 seconds. The system 100 further concludes that it will be safe to change the drive lane to the right (or make a right-turn) if the driver makes the move immediately. In this scenario, the indicators showing i) it is safe to turn right and ii) the right-turn must be made immediately will both be flashing. It should be noted that the indicators shown in FIG. 4 are exemplary merely. There could be other suggestive ways not illustrated thereon, for instance, slow down/speed up the vehicle 10. Thus, the illustrations on FIG. 4 should under no circumstance become a limitation to the present invention.

Moreover, in another embodiment of the present invention the driver's planned route will also be considered when giving advices. The planned route may be determined by a pre-input route, a change of the gear, or an enablement of a turn signal. Assuming an object is approaching at the rear-left side of the vehicle 10, the sensing module 110 gathers the parameters with respect to the object including the status of the object, the moving direction and the velocity, if applicable, of the object, and the distance between the vehicle 10 and the object. Moreover, as mentioned above, the parameters in relation to, for example, the traffic condition and the width of the lane are also considered. Aside from these parameters, while evaluating the feasible recommendations, the arithmetic unit 120 in the current embodiment further considers the driver's planned route. For instance, assuming the vehicle 10 is moving forward and meanwhile the driver issues the right-turn signal and is about to make a right turn. Under the scenario, the advices given by the present invention will also take the driver's intention into account to avoid possible collisions. Precisely, since the object is at the rear-left side of the vehicle 10 and the driver's planned route would likely to avoid the possible collision, the system 100 of the present invention may instruct the driver to make the turn right away provided there is no obstacle in the drive lane that the driver intends to go.

On the other hand, assuming the driver plans to make a left turn instead. The arithmetic unit 120 determines that the left-turn would increase the chance of collision between the vehicle 10 and the object located close by the rear-left side of the vehicle 10, the system 100 then advises the driver either not to make the turn or tell the driver how much time left to make the planned turn without being collided with the object. Similarly, the informative data including the advices are presented on the display device 130.

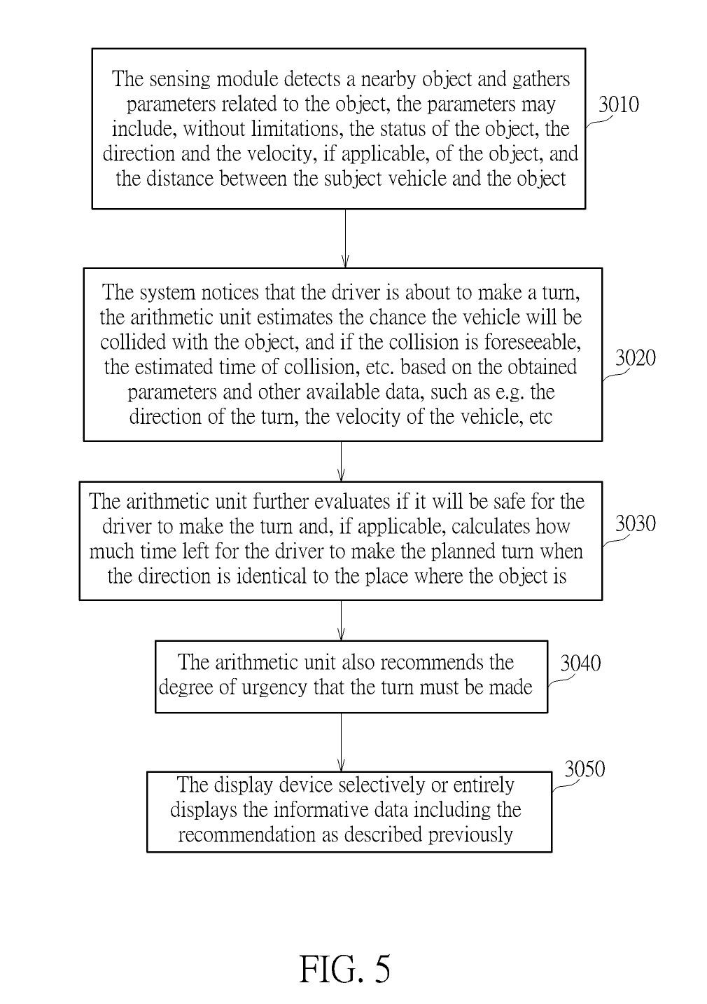

The least steps of proceeding the above scenario are summarized in FIG. 5 and as follows:

Step 3010: the sensing module 110 detects a nearby object and gathers parameters related to the object, the parameters may include, without limitations, the status of the object, the direction and the velocity, if applicable, of the object, and the distance between the subject vehicle and the object.

Step 3020: the system 100 notices that the driver is about to make a turn, the arithmetic unit 120 estimates the chance the vehicle 10 will be collided with the object, and if the collision is foreseeable, the estimated time of collision, etc. based on the obtained parameters and other available data, such as e.g. the direction of the turn, the velocity of the vehicle 10, etc.

Step 3030: the arithmetic unit 120 further evaluates if it will be safe for the driver to make the turn and, if applicable, calculates how much time left for the driver to make the planned turn when the direction is identical to the place where the object is.

Step 3040: the arithmetic unit 120 also recommends the degree of urgency that the turn must be made.

Step 3050: the display device 130 selectively or entirely displays the informative data including the recommendation as described previously.

In another embodiment, the system 100 may only provide the informative data solely related to the planned route. Precisely, if the driver intends to make a right turn, the system 100 will then only consider the possible collision at the right-hand side and ignore the potential obstacles at the left-hand side since the risk of collision at the left-hand side would be low. In other words, the evaluation will only be conducted when a planned route is ascertained. In doing so, the arithmetic unit 120 can decrease its processing time of the estimations and therefore provide only necessary information with less distraction to the driver in a prompt way.

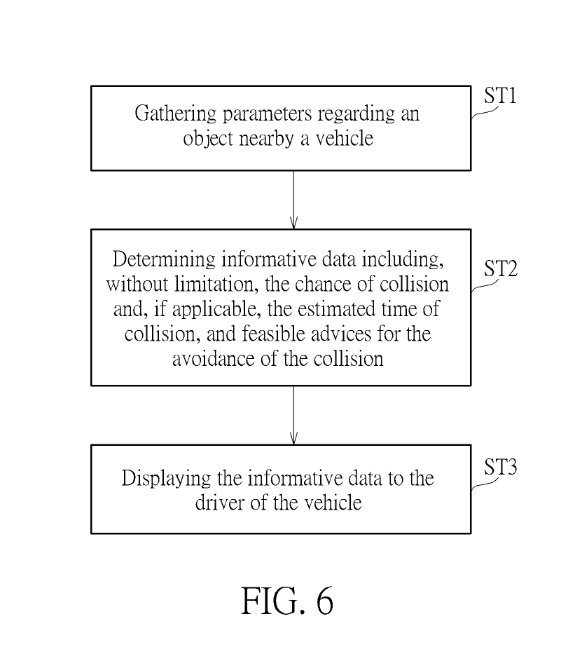

In brief, the method of providing informative data as well as suggestions for the avoidance of collision in accordance with the present invention shown in FIG. 6 includes the following steps:

Step ST1: gathering parameters regarding an object nearby a vehicle;

Step ST2: determining informative data including, without limitation, the chance of collision and, if applicable, the estimated time of collision, and feasible advices for the avoidance of the collision; and

Step ST3: displaying the informative data to the driver of the vehicle.

The parameters may include the status of the object (i.e. is it moving or still), the velocity and direction of the object if it is moving, and the distance between the object and the vehicle. Additionally, the parameters may also include the vehicle's velocity and direction, the traffic condition and the width of lane etc. Moreover, it may also include the driver's planned route which may be ascertained when the driver issues a turn signal.

As for the informative data, it may contain the chance of collision, the estimated time of collision, if applicable, and feasible recommendations to avoid the collision. The informative data is presented on a display device to inform the driver. Depending on the preferences and design choices, the system may further determine the degree of urgency in response to the possible collision.

It should be noted that the above flowcharts are conceptually illustrated merely. The orders of the steps taken to furnish the present invention may not be exactly the same as depicted above and in the diagrams. Further, some step may be swapped with another, and some additional process may be added. For example, as disclosed early, the sensing module may only start collecting parameters regarding the relevant object at the right-hand side when the driver issues the right indicator and is about to make a right turn.

To sum up, in light of the foregoing, the present invention provides a system and a method that not only warns drivers as for the existence of objects in the blind spots but also gives informative data to the driver. Particularly, the present invention further suggests feasible advices, such as change the drive lane, make a turn, slow down or speed up, etc. and how urgent an act must be completed for the avoidance of foreseeable collision.

Those skilled in the art will readily observe that numerous modifications and alterations of the device and method may be made while retaining the teachings of the invention. Accordingly, the above disclosure should be construed as limited only by the metes and bounds of the appended claims.

1. A blind spot informative system, comprising:
a sensing module disposed in a vehicle and configured to detect and gather a plurality of parameters of an object nearby the vehicle;
an arithmetic unit configured to evaluate a chance the object would collide with the vehicle and, if a collision is foreseeable, an estimated time of collision based on the parameters and available data, wherein the arithmetic unit is further configured to evaluate at least one feasible advice to avoid the foreseeable collision based on the parameters and the available data, and the available data comprises a planned route of the vehicle; and
a display device configured to display the estimated time of collision and the feasible advice to inform a driver of the vehicle.

2. The blind spot informative system of claim 1, wherein the parameters comprise status of the object, a direction and a velocity of the object, and a distance between the object and the vehicle.

3. The blind spot informative system of claim 1, further comprising a sensor and a communication device configured to collect the available data comprising a direction and a velocity of the vehicle, the planned route of the vehicle, traffic conditions and widths of lanes.

4. (canceled)

5. The blind spot informative system of claim 1, the feasible advice is an advice to change a drive lane, an advice to speed up the vehicle, an advice to slow down the vehicle, or an advice to make a turn at a specific direction.

6. The blind spot informative system of claim 5, wherein the feasible advice further comprises a degree of urgency in response to the collision.

7. The blind spot informative system of claim 1, wherein the arithmetic unit is configured to only evaluate an informative data upon an ascertainment of the planned route of the vehicle.

8. The blind spot informative system of claim 1, the sensing module further comprises a plurality of sub-sensing modules configured to detect and collect parameters of nearby objects at different directions.

9. An informative method, comprising:
collecting parameters of an object nearby a vehicle upon a detection of the object, wherein the parameters at least comprise a velocity of the object and a distance between the object and the vehicle;
estimating a chance that the object would collide with the vehicle based on the parameters and a planned route of the vehicle, and if the collision is foreseeable, an estimated time of collision;
evaluating at least one feasible advice for avoiding the collision based on the parameters and the planned route; and
presenting the estimated time of collision and the feasible advice to a driver of the vehicle.

10. The informative method of claim 9, wherein
the feasible advice for avoiding the collision is evaluated based on the parameters, the planned route, a velocity and a direction of the vehicle, traffic conditions, and widths of lanes.

11. The informative method of claim 10, wherein the planned route of the vehicle is ascertained when the driver of the vehicle issues a turn signal.

12. The informative method of claim 11, wherein the evaluation step only is proceeded upon the ascertainment of the planned route.

13. The informative method of claim 10, wherein the feasible advice is an advice to change a drive lane, an advice to speed up the vehicle, an advice to slow down the vehicle, or an advice to make a turn at a specific direction.

14. The informative method of claim 10, further comprising estimating and presenting a degree of urgency in response to the collision.

15. A blind spot informative system implemented in a vehicle driving in accordance with a planned route, comprising:
a sensing module disposed in a vehicle and configured to detect an object within a blind spot of the vehicle and collect a velocity of the object and a distance between the object and the vehicle;
an arithmetic unit connected to the sensing module and configured to evaluate a chance the object would collide with the vehicle, and if the collision is foreseeable, an estimated time of collision based on the planned route, the velocity of the object and the distance between the object and the vehicle, wherein the arithmetic unit is further configured to evaluate at least one feasible advice to avoid the foreseeable collision based on the velocity of the object, the distance between the object and the vehicle and the planned route; and
a display device configured to display the estimated time of collision in line with the planned route and display the feasible advice to a driver of the vehicle.

16. The blind spot informative system of claim 15, wherein if the vehicle is about to turn right, the arithmetic unit is configured to only evaluate the chance of collision and the estimated time of the collision at the right-hand side; alternatively, if the vehicle is about to turn left, the arithmetic unit is configured to only assess the chance of collision and the estimated time of collision at the left-hand side.

17. The blind spot informative system of claim 15, the feasible advice is evaluated by further considering the estimated time of collision, a velocity of the vehicle, traffic conditions and widths of lanes.

18. The blind spot informative system of claim 17, wherein the feasible advice may be an advice to change a drive lane, an advice to slow down the vehicle, an advice to speed up the vehicle, or an advice to make a turn at a specific direction.

19. The blind spot informative system of claim 17, the arithmetic unit is further configured to evaluate a degree of urgency in response to the collision.

20. The blind spot informative system of claim 19, wherein the display device is configured to further represent the degree of urgency in response to the collision.
